(19) United States
(12) Patent Application Publication
(10) Pub. No.: US 2023/0347933 A1
(43) Pub. Date: Nov. 2, 2023

(54) METHOD FOR VALIDATING A CONTROL SOFTWARE FOR A ROBOTIC DEVICE

(71) Applicant: Robert Bosch GmbH, Stuttgart (DE)

(72) Inventors: Jan Stellet, Stuttgart (DE); Nils Tiemann, Ludwigsburg (DE); Stefan Aulbach, Leonberg (DE)

(21) Appl. No.: 18/178,413

(22) Filed: Mar. 3, 2023

(30) Foreign Application Priority Data
Mar. 31, 2022 (DE) 10 2022 203 171.7

(51) Int. Cl. B60W 50/06; B60W 30/095; B60W 60/00

(52) U.S. Cl. CPC B60W 60/0015; B60W 30/095; B60W 50/06

(57) ABSTRACT

A method for controlling a robotic device. The method includes producing control software for the robotic device, carrying out field tests using the control software, determining scenarios in which events with at least a specified criticality (i.e., a specified value of a criticality metric) have arisen in the field tests, and determining, for each determined scenario, the frequency with which the determined scenario including an event with at least the specified criticality occurs, carrying out simulations for each determined scenario, determining, from the simulations, a collision rate for each determined scenario, combining the determined collision rates into an average (in other words overall) collision risk over all the determined scenarios, taking account of the determined frequency and controlling the robotic device using the control software if the average collision risk fulfills a specified safety criterion.

### CROSS REFERENCE

The present application claims the benefit under 35 U.S.C. § 119 of German Patent Application No. DE 10 2022 203 171.7 filed on Mar. 31, 2022, which is expressly incorporated herein by reference in its entirety.

### FIELD

The present invention relates to methods for validating a control software for a robotic device.

### BACKGROUND INFORMATION

Control software for robotic devices such as for example vehicles (in particular autonomous vehicles) is subject to stringent safety requirements. In the case of autonomous vehicles, it must be ensured, for example, that the risk of collision in scenarios which occur in real-life road traffic is sufficiently low before the vehicle is controlled using the control software, this also being known as control software validation.

Approaches are desirable which allow, with high data efficiency and reliability, for such a validation.

### SUMMARY

According to various embodiments of the present invention, a method for validating a control software for a robotic device is provided which includes carrying out field tests using the control software, determining scenarios in which events with at least one specified criticality (i.e. a specified value of a criticality metric) have arisen in the field tests, and determining, for each determined scenario, the frequency with which the determined scenario including an event with at least the specified criticality occurs, carrying out simulations for each determined scenario, determining, from the simulations, a collision rate for each determined scenario, combining the determined collision rates into an average (in other words, overall) collision risk over all the determined scenarios, taking account of the determined frequency (e.g. by appropriate weighting of a collision rate depending on the frequency which was determined for the scenario for which the collision rate was determined) and validating the control software on the basis of a comparison of the average collision risk with a safety criterion.

The above-described method allows a data-efficient decision-making process with regard to the use of control software for a robotic device because use is made of simulations to determine whether control with the control software is safe. However, it also establishes a link with the real world because the scenarios for which simulations are carried out originate from field tests. Furthermore, an overall collision rate is used which takes account of how often specific scenarios arise in practice.

In this way, control software validation (with demanding validation objectives) and thus for example rapid software update cycles can be achieved for control of a robotic device, such as for example a vehicle, with low field test effort, i.e. with high data efficiency. Ultimately, this increases software development efficiency because, for example, improved control software can be released more rapidly (with low validation effort).

Generally, no (serious) collisions will occur in a field test of manageable scope, i.e., it is not necessary to carry out the field test until (serious) collisions have occurred. Nevertheless, using the simulations, it is possible to determine a collision rate (including for collisions of high collision severity).

Various exemplary embodiments of the present invention are indicated below.

Exemplary embodiment 1 is a method for validating control software for a robotic device, as described above.

Exemplary embodiment 2 is the method according to exemplary embodiment 1, wherein criticality is specified in such a way that the scenarios include scenarios in which no collision has occurred.

In other words, scenarios with subcritical events are considered. This allows the collision risk to be determined even when no collisions have occurred in field testing, so resulting in high data efficiency.

Exemplary embodiment 3 is the method according to exemplary embodiment 1 or 2, including determining the collision rates and an average collision rate, from the determined collision rates, for each degree of collision severity for at least one degree of collision severity and determining the average collision risk from the average collision rate for each degree of collision severity.

The collision rate may thus be determined for each degree of collision severity. It is accordingly possible, for example, to configure and evaluate the safety criterion as a function of the degree of collision severity.

Exemplary embodiment 4 is the method according to one of exemplary embodiments 1 to 3, further including determining an average collision rate from the determined collision rates and determining an extrapolated collision rate across the determined scenarios from results of the field tests by statistical extrapolation (of subcritical events, i.e. extrapolation from the selected scenarios from the field test) and comparing the average collision rate (ascertained for example from simulation of the determined scenarios by weighted averaging) with the determined extrapolated collision rate.

For example, it is checked whether the determined average collision rate lies in the range of the determined extrapolated collision rate. In this way, it is possible to check whether the assumptions made for the simulation are justified.

To this end, confidence intervals may be ascertained during extrapolation of the collision rate from subcritical events. Any systematic deviation of the simulation result (and thus invalid assumptions for the simulation) may therefore be identified from the extrapolated collision rate, for example if the simulation results lie outside a 95% confidence interval of the extrapolation result. Type 1 error probability (i.e. the probability of rejecting a valid simulation) would then be 5%.

For the extrapolation, the data (random samples) from the field tests may be additionally extended by simulated data points and used as the basis for the extrapolation. This reduces uncertainty during extrapolation.

Exemplary embodiment 5 is the method according to one of exemplary embodiments 1 to 4, wherein for each determined scenario a Monte Carlo simulation is carried out in which parameters of the scenario are randomly varied.

This makes it possible for many cases (and events), which may occur within the context of the respective scenario, to be fully utilized and in particular also for critical events (i.e. unavoidable collisions), which did not arise at all during field testing, to be acquired by the simulations.

Exemplary embodiment 6 is a validating apparatus which is set up to receive field test data from field tests carried out using control software, to determine scenarios in which events with at least one specified criticality occurred in the field tests, and determining, for each ascertained scenario, a frequency with which the ascertained scenario including an event with at least the specified criticality occurs, to carry out simulations for each determined scenario, to determine, from the simulations, a collision rate for each determined scenario, to combine the determined collision rates into an average collision risk over all the determined scenarios taking account of the determined frequency and to validate the control software on the basis of a comparison of the average collision risk with a safety criterion.

Exemplary embodiment 7 is a method that includes: receiving field test data from field tests carried out using a control software, determining scenarios in which events with at least one specified criticality occurred in the field test, and determining, for each determined scenario, a frequency with which the ascertained scenario including an event with at least the specified criticality occurs, carrying out simulations for each determined scenario, determining, from the simulations, a collision rate for each determined scenario, combining the determined collision rates into an average collision risk over all the determined scenarios taking account of the determined frequency and validating the control software on the basis of a comparison of the average collision risk with a safety criterion.

Exemplary embodiment 8 is a computer-readable medium which stores commands which, when executed by a processor, cause the processor to carry out a method that includes: receiving field test data from field tests carried out using a control software, determining scenarios in which events with at least one specified criticality occurred in the field tests, and determining, for each determined scenario, a frequency with which the ascertained scenario including an event with at least the specified criticality occurs, carrying out simulations for each determined scenario, determining, from the simulations, a collision rate for each determined scenario, combining the determined collision rates into an average collision risk over all the determined scenarios taking account of the determined frequency and validating the control software on the basis of a comparison of the average collision risk with a safety criterion.

In the figures, similar reference signs generally relate to the same parts in all the different views. The figures are not necessarily to scale, the emphasis generally instead being on depicting the principles of the present invention. In the following description, various aspects are described with reference to the figures.

### BRIEF DESCRIPTION OF THE DRAWINGS

FIG. 1 shows a vehicle according to an example embodiment of the present invention.

FIG. 2 shows a flowchart which shows a method for determining a collision risk according to various example embodiments of the present invention.

FIG. 3 illustrates statistical extrapolation.

FIG. 4 shows a flowchart depicting a method of validating a control software for a robotic device according to one example embodiment of the present invention.

### DETAILED DESCRIPTION OF EXAMPLE EMBODIMENTS

The following detailed description relates to the figures which, for the purpose of explanation, show specific details and aspects of this disclosure which enable the present invention to be carried out. Other aspects may be used, and structural, logical and electrical changes may be made without deviating from the scope of protection of the present invention. The various aspects of this disclosure are not necessarily mutually exclusive because some aspects of this disclosure may be combined with one or more other aspects of this disclosure to form new aspects.

Various examples are described in greater detail below.

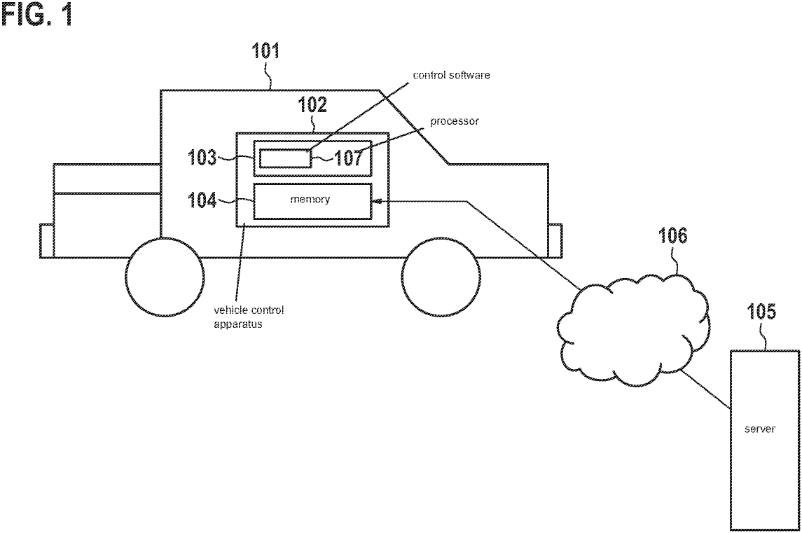

FIG. 1 shows a vehicle 101.

In the example of FIG. 1, a vehicle 101, for example a (passenger) car or truck, is provided with a vehicle control apparatus (for example an electronic control unit (ECU)) 102.

The vehicle control apparatus 102 has data processing components, for example a processor (e.g. a CPU (central unit)) 103 and a memory 104 for storing control software 107, according to which the vehicle control apparatus 102 operates, and data, which are processed by the processor 103. The processor 103 executes the control software 107.

For example, the stored control software (computer program) has instructions which, when the processor executes them, cause the processor 103 to execute driver assistance functions (or indeed to collect driving data) or even cause the vehicle to control itself autonomously.

The control software 107 is transmitted for example by a server 105, for example via a network 106, to the vehicle 101. This may also take place during operation (or at least, when the vehicle 101 is in the user’s possession) because the control software 107 is, for example, updated with new versions over the course of time.

In such a context, it is very important for each version of the control software 107 transmitted to the vehicle 101 and used therein for control purposes to enable safe control of the vehicle 101. To this end, the control software 107 is typically validated.

Terms which typically arise or are significant in connection with such validation are indicated below.
HAV: Highly automated vehicle, wherein the focus is on the system for automated driving and is very largely invariant with regard to the base vehicle.
Conflict (near miss): Traffic situation in which a collision between two or more road users or departure from the roadway would occur if the current movement trajectory were to be continued. Conflicts occur frequently and as a rule are mitigated by evasive maneuvers (typically braking or sideways evasion). The degree of evasive maneuvering required or already carried out may be used as a measure of the severity of a near miss (see also criticality metric).
Collision: Contact with another object (e.g. road user, stationary obstacle) and/or departure from the roadway. The effects of a collision (damage/injury) may be measured using collision severity classes.
Criticality metric: Normalized, continuous variable (hereinafter also written as κ), which measures the degree of evasive maneuvering needed in the event of a conflict. The variable is normalized such that the value x_{crit} = 1 corresponds to an (unavoidable) collision. Values below the normalized value x_{crit} = 1 but above a threshold u to be selected are denoted “subcritical” (see also subcritical events). Criticality metrics may for example be defined based on physical motion variables (for example longitudinal or lateral acceleration) or based on time (for example time to collision). Different criticality metrics may be used.
Collision probability: Probability that a (or at least one) collision will occur within a defined time or distance window.
Collision rate: Expected value for the number of collisions during a unit of driving time or of driven distance. Typically, one hour or kilometer is selected as the reference variable, such that the collision rate is stated as the unit ⅟h or ⅟km. Since collisions are very rare events, the occurrence thereof is typically characterized using a Poisson process. Alternatively or in addition, the following assumptions may for instance be made (taking a collision rate per unit time by way of example):
   ◯ the collision probability p_{K}(T) is dependent solely on the length of the underlying time window T;
   ◯ in a time window of length Tₑₗₑₘ, no more than one collision can occur and all considered time windows of length Tₑₗₑₘ are temporally disjoint.
   It thus follows that the collision rate λ_{K} is constant over time (stationary) and can be ascertained as follows from the collision probability for Tₑₗₑₘ:
$${λ}_{K} = \frac{{p}_{K} \left({T}_{\text{elem}}\right)}{{T}_{\text{elem}}}$$
Based on these assumptions, the collision rate is obtained by scaling the collision probability with the duration of the time window, whereby the two variables can be rapidly interconverted and likewise used to describe the same validation objectives.
Collision severity class: Evaluation of the damage/injury caused by a collision using discrete collision severity classes, for example according to the abbreviated injury scale (AIS) pursuant to ISO 26262:2018, with four collision severity classes from S0 (no injuries) to S3 (life-threatening (survival uncertain) to fatal injuries). The collision severity class can be used to define the collision severity distribution for a set of collisions, i.e. the relative proportions of each collision severity class.
Collision risk: Collision rate based on a specific collision severity class.
Validation target (evidence target): Upper limit for the collision risk for control software 107, which is to be shown by validation. Since the collision risk results from the collision rate and collision severity, there may be different validation targets for the rate of collisions with different collision severity classes. A distinction should be drawn between this evidence target and the design target for an HAV. While the actual collision risk can and should be as low as possible (e.g. design target 0), the risk verifiable using a statistical validation method is always greater than zero. The validation target may therefore also be understood as a residual risk.
HAV field test (“field test”): Random (representative) driving test for the HAV (for example vehicle 101) in the intended operating area. During this field test, the HAV drives fully autonomously (“closed loop”), but is monitored by a safety driver. The sensor data or internal system states of the HAV at a suitable interface are typically recorded and criticality metrics may for example be subsequently calculated or simulation-based tests carried out. This is relevant for example in order to test, in the event of the safety driver taking over control of the vehicle, whether the HAV would likewise have been capable of continuing to control the vehicle safely or whether a collision would actually have taken place. The necessary duration of or distance covered by a field test is dependent on the validation target and evaluation method. While typical validation targets for driver assistance systems over practicable distances can still be verified using a “black-box” test evaluation method (using a “Poisson distribution” as the statistical model), the distances needed for HAVs are several orders of magnitude too high to be feasibly implemented. The term field test includes the recording of sensor measurements and post-processing (for example the preprocessing described below, e.g. “post-simulation” with a different software version).
Subcritical events: During a field test the value of a criticality metric is calculated at any given time. Times at which this exceeds a defined threshold u below the normalized value x_{crit} = 1 are denoted subcritical events. These events correspond to data points in the recorded field test data which are particularly relevant for statistical extrapolation or simulation-based tests.
Statistical extrapolation: The application of statistical (extrapolation) models to recorded field test data, in particular data relating to subcritical events, to estimate the rate of critical events (here: collisions). By applying a suitable statistical (extrapolation) model, it is typically possible to show a lower rate (more demanding validation target) than when applying a Poisson model in the black-box test. According to various embodiments, such an approach is applied to validation targets relating to collision risks. When using a one-dimensional criticality measure, the statistical model for the extrapolation is also one of a family of one-dimensional models. In the exemplary embodiments described below, such a one-dimensional criticality measure is assumed for the sake of simplicity. An extension to multidimensional criticality measures and models is however also possible. In the simplest case, there are then two one-dimensional criticality measures. A minimum criticality is then fulfilled (e.g. an event then has at least one specified criticality), if at least one of the values of a measure exceeds a specified value. The remaining procedure is similar to the one-dimensional case.
Simulation-based HAV testing (“simulation”): HAV testing in a virtual environment, wherein the vehicle surroundings and the interaction of the HAV therewith are modeled by models (for example sensor models and models of road user behavior). Tests may therefore be controlled and reproduced. A test may be repeated multiple times, wherein individual or multiple (input) parameters are varied using a statistical model. This is known as a Monte Carlo simulation. In this way, an estimate can be determined of the probability distribution in the simulation observable variables, including, for example, the distribution of a criticality measure, given the statistical model of the variable (input) parameters.

It should be taken into account that a) the simulation models may also include differences from the real world, which may for example be statistically modeled and b) a Monte Carlo simulation cannot currently fully replace a field test because not all relevant parameters are known a priori and the sum of the dimensions of all relevant parameters prevents practical implementation.

For these reasons, in practice Monte Carlo simulations are scenario-based, i.e. are used for individual time-limited scenarios in which in each case only a small proportion of the parameters are varied, whereas others remain constant for all repeats.

Scenario: (Brief) traffic timeline (i.e. sequence of traffic situations). Described in a suitably formalized manner (scenario description language), this timeline is part of the description of a simulation-based test. In the process of formalization, scenario parameters can be identified and varied according to a suitable parameter distribution in a Monte Carlo simulation. Since a field test is made up of a sequence of scenarios, when subcritical events occur, the associated scenarios can be extracted from the field test data and used for a simulation-based test. By varying scenario parameters, variants may then also be tested which were not observed at all in the field test. The field test information may be expanded thereby. The scenarios associated with subcritical events are also known as subcritical scenarios. A scenario is thus denoted subcritical if an associated subcritical event was observed, the scenario thus being considered relevant for further interpretation. This does not however mean that in this scenario exclusively at least subcritical events can be observed.

According to various embodiments, as described hereinafter, field test data, criticality metric values, Monte Carlo simulations for individual subcritical scenarios and statistical extrapolation are associated (i.e. combined) for validation of control software (with a validation objective regarding collision risk and taking account of collision severity) for an HAV, or in general a robotic device.

According to various embodiments, an evaluation method is provided for estimating an upper confidence interval bound as evidence for one or more validation targets for the collision risk of an HAV.

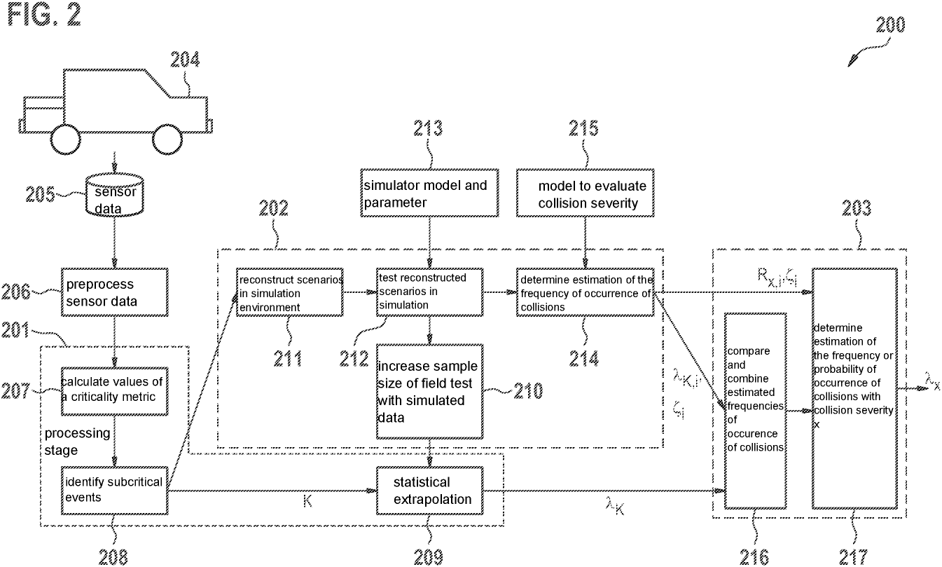

FIG. 2 shows a flowchart 200, which shows a method for determining a collision risk according to various embodiments. This method is carried out by the server 105, for example, which decides on the basis of the results of the method whether control software 107 (for example a new version) is to be loaded onto the vehicle 101 for control purposes.

In this case, a collision risk, i.e. for example the rate of collisions with high collision severity as a subset of all collisions, is determined in three processing stages.
1. In 201, the overall collision rate λ_{K} is estimated, using statistical extrapolation applied to subcritical events which have occurred in a field test of an HAV 204 supplying sensor data 205.
2. In 202, the subcritical scenarios associated with N_{scenarios} are extracted from the information from the field test. (Alternatively or in addition, all scenarios (not just subcritical ones) may also be extracted from the data and used for the following purposes). The frequency of occurrence of these scenarios is also estimated in this step (statistical scenario weightings). This estimation also includes the presence of at least subcritical events. A Monte Carlo simulation is then performed for each of the i = 1, ..., N_{scenarios} subcritical scenarios. In this case, both the scenario parameters of the vehicle surroundings, for example behavior and initial position of other road users, and influences on HAV performance, for example sensor measuring noise, are varied by suitable statistical simulation models. Given a sufficiently large number of Monte Carlo simulations, collisions will also occur in the simulation-based test, such that it is in each case possible to estimate the collision rate λ_{K,i} (based on all the at least subcritical events in simulations of the respective scenarios), collision severity and, overall, collision severity distribution in the respectively observed scenario. This gives rise, for each collision severity class, to an estimate of the proportion R_{x,i} relative to all collisions in the Monte Carlo simulations associated with the scenario i.
3. In 203, from a combination of the collision rates λ_{K,i}, the scenario weightings ζᵢ and the estimated proportions R_{x,i} for collisions with a severity class Sₓ and the estimate from 201, an estimate is finally determined for the collision risk λₓ for the severity class.

Estimation of the collision risk is taken to mean, for example, the estimation of the upper limit of a confidence interval and not a point estimate. For the sake of simplicity, no further distinction is drawn here, with reference merely being made generally to an estimation. The sequences are similar for both cases.

Without restricting the general applicability of the possible scales for collision severity, these are denoted severity class Sₓ and may also comprise multiple successive classes on a specific scale.

The sequence, in particular the above-stated three processing stages 201, 202, 203, is explained in more detail below.

In 206, the (environment) sensor data 205 are preprocessed. The physical variables needed for calculating criticality in processing stage 201 are acquired by the environment sensor system of the HAV 204 and optionally supplemented by high-precision map information. In preprocessing, the acquired data are corrected and thus reference environment data generated, such that divergent environment data do not result in calculation of an incorrect, in particular excessively low, criticality.

To estimate an overall collision rate using statistical extrapolation in processing stage 201, in 207 the values of a criticality metric are calculated for events from the field tests (this gives rise to a criticality time profile in the field tests). On the basis of the values of the criticality metric, in 208 subcritical events are selected.

A criticality-based metric (i.e. a criticality metric) expresses at all times, as a continuous, unique value, how critical the current traffic situation is. Various combinations of physical variables are considered as criticality metrics when it comes to defining a measure of collision probability. The criticality metric is ascertained from the complete field test data and thus produces a value κ for each time step. In a first step, these values are aggregated over a short time window Tₑₗₑₘ e.g. by the formation of maxima. This serves (sufficiently) to ensure the prerequisite of stochastic independence of the events considered below. In a second step, those of the aggregated values which lie above a threshold u to be selected are identified as subcritical events. Formally, the threshold u is the lower limit of the definition range of the generalized Pareto distribution (see below). In practice, this value is typically unknown and statistical tests and control methods are applied to the values κ. Only these selected subcritical events are subsequently further investigated and processed (in processing stage 201, specifically statistical extrapolation 209, and in processing stage 202).

In 209, statistical extrapolation is carried out, so as to estimate the probability of a collision not observed in the field test.

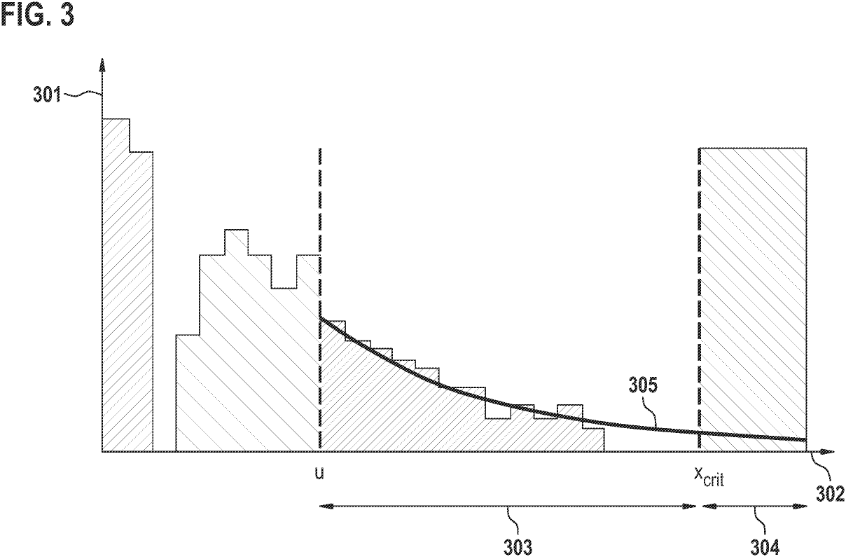

FIG. 3 illustrates statistical extrapolation.

Relative frequency is plotted on the y axis 301. The criticality metric is plotted on the x axis 302. This in particular includes a subcritical region 303 and a region 304 in which the field test has not supplied any data (because no collisions took place in the field test).

In this example, extrapolation is based on stochastically independent, identically distributed criticality values κ and assumes that the distribution function thereof above the subcritical threshold u can be modeled or approximated by a “generalized Pareto distribution” (GPD) (illustrated by graph 305). An alternative embodiment uses “(generalized) extreme value distributions” (primarily when observing maxima instead of instances where threshold values are exceeded) or distributions which approach a (generalized) extreme value distribution or a GPD - i.e. lie within the “domain of attraction” thereof.

A GPD is a model from extreme value theory, which is tailored to uncommon instances of high threshold values being exceeded. The underlying model equation is:

$$\text{P} \left(κ \geq x\right) = {ζ}_{u} {\left(1 + ξ \frac{x - u}{σ}\right)}^{- 1 / ξ} \text{for all} x \geq u .$$

In this case, the subcritical threshold value u characterizes the beginning of the subcritical range and ζᵤ is the probability of this threshold value being exceeded and thus an at least subcritical value being observed; the remaining parameters ξ, σ relate exclusively to distribution above the subcritical threshold value.

Since the selection of the threshold value u influences both the probability ζᵤ and the GPD model of the probability of a still higher value being exceeded, the probability P(κ ≥ x) does not change on modification thereof; the sole prerequisite is that the threshold value be selected to be high enough to justify modeling using a GPD. The specific selection of u, however, has a practical influence on the quality of estimation of the other model parameters of the GPD model.

After estimating the model parameters, the use of x = x_{crit} = 1 in the above model equation results in an estimation of collision probability. In relation to the time base, the collision rate λ_{K} is obtained. Mathematical limit theorems, the structure of which is reflected in the GPD model, allow this estimation even though no collisions were contained in the observed data (they constitute a type of “central limit theorem” for extreme observations).

In addition to the collision probability or collision rate estimation (point estimate), the parameter estimation methods also yield an indication of the statistical uncertainty of this estimation. The width of the (realization of a) confidence interval is an indication of the uncertainty underlying the estimate. Even if confidence intervals do not as a rule have any explicit mathematical representation, their width normally reduces as the sample size grows, which clearly corresponds to falling statistical uncertainty. For this reason, according to one embodiment in 210, as part of processing stage 202, the sampling size of the field test is further widened by simulated data points, so reducing the uncertainty of the extrapolation in 209.

In processing stage 202, the identified subcritical scenarios are used as the basis for a simulation-based test.

The subcritical events selected in 208 are to this end initially clustered into different scenarios.

Depending on the form taken by the method, the server 105 may for example
interpret each subcritical event (specifically, the sequence of associated relevant situations and parameters) as a self-contained scenario; or
combine a plurality of subcritical events, whose associated relevant situations and parameters resemble one another, into a common scenario. Similarities may for example result from comparable traffic situations and maneuvers carried out and/or also from comparable physical parameters (such as distances, speeds, acceleration etc.); optionally, such similarities may be revealed by statistical methods. Such a combination of subcritical events into scenarios makes it possible for the observed situation and parameter distributions to produce important pointers to realistic parameter variations in the Monte Carlo simulation.

These scenarios are then reconstructed in the simulation in 211 and then in 212 they are tested (using a simulation model and parameter distributions 213) with statistical variations and various influences on HAV performance, e.g. sensor measuring noise, resulting in new situations including both subcritical and critical examples.

A particular instance of a simulation environment is not required for this purpose. A criterion regarding simulation quality is whether the statistical variations of the scenarios generated according to representative distribution (as part of the “world model”) and the simulated influences on HAV performance as a whole lead to sufficiently accurate estimation of collision probability and severity distribution in the simulation. It is thus not required, for example, that the raw sensor data has to be explicitly simulated by models, an instance with simulation of the HAV component “Perception” or “Environment Model” likewise being possible.

In the case of the use described herein of a simulation environment, only individual selected (subcritical) scenarios need to be simulated. Simulation quality can therefore be assessed in targeted manner for each scenario (and the generated variations) and does not have to be verified generically for all, including a priori unknown, scenarios.

As mentioned above, results of the simulations may be used to improve statistical extrapolation in 209 (increase in confidence).

Given a sufficient number of Monte Carlo simulations in 214, an estimation of the frequency of occurrence of collisions is determined. In this case, using a model 215 to evaluate collision severity, e.g. on the basis of impact velocity and angle, collision severity can also be estimated in the simulation.

This leads to estimation of the proportion R_{x,i} of collision severity Sₓ relative to all collisions for the scenario i; formally: R_{x,i} = P(Sₓ | κ ≥ x_{crit}, S = i), wherein S = i denotes scenario i.

In processing stage 203, the results of the processing stages 201 and 202 are then combined to estimate the collision risk.

To this end, in 216, the estimated overall collision rate from the extrapolation 209 and the estimated collision rates from the simulations of 214 in individual subcritical scenarios are compared and combined.

A comparison between these results of processing stages 201 and 202 is possible because it is also possible to draw conclusions from the collision rates λ_{K,i} (based on all at least subcritical events in the respective scenario) about the overall collision rate λ_{K}. This is described by the following equation for comparing collision probabilities:

$$P \left(κ \geq {x}_{c r i t}\right) = {\sum }_{i = 1}^{{N}_{s c e n a r i o s}} {ζ}_{i} P \left(κ \geq {x}_{c r i t} \left|κ \geq u , S = i\right)\right)$$

Using the Monte Carlo simulations, for each observed scenario (ith scenario, S = i) the conditional probability P(κ ≥ x_{crit} | κ ≥ u, S = i) is estimated separately as the relative frequency of all collisions among the at least subcritical events which are associated with this scenario. If no collisions have occurred even in the Monte Carlo simulations, an attempt may be made to estimate this probability for this scenario through statistical extrapolation.

The variable ζᵢ = P(κ ≥ u, S = i) is obtained in the field test, like ζᵤ, for example as a relative frequency of all subcritical events, which are associated with scenario number i. To ascertain ζᵢ, the preprocessed data (in 206) are also used and not just the subcritical events from 208 (to obtain the relative proportion with respect to all, not just to subcritical, data).

Through summation over all scenarios, a second point estimate is obtained for the collision probability (in addition to that from the extrapolation from 209). The actual comparison now consists in comparing this second point estimate with the point estimate from the extrapolation 209. If the assumptions made for the simulation are justified, the two estimations should be close together.

For the comparison, the point estimate from 209 may be used, prior to any augmentation with data from the simulation of processing stage 202, so as not to produce any circularity.

In 217, the rate λₓ or probability P(Sₓ) which is ultimately to be estimated is ascertained for the occurrence of a collision of severity class Sₓ. To this end, firstly the overall ratio Rₓ is ascertained for the frequency of occurrence of the severity class Sₓ relative to all collisions. This results for i = 1, ..., N_{scenarios} from the ratio R_{x,i}, estimated in processing stage 202, for the frequency of occurrence of the severity class Sₓ relative to all collisions in the i^{th} scenario and the relative frequency ζᵢ with which scenario i arises and includes a subcritical event, as well as the probability of a collision P(κ ≥ x_{crit} | κ ≥ u, S = i) based on all at least subcritical events in the scenario i (the associated rate is denoted λ_{K,i}), according to:

$${R}_{x} = \frac{{\sum }_{i = 1}^{{N}_{s c e n a r i a s}} {}_{i} P \left(κ \geq {x}_{c r i t} \left|κ \geq u , S = i\right)\right) {T}_{x , i}}{{\sum }_{i = 1}^{{N}_{s c e n a r i o s}} {ζ}_{i} P \left(κ \geq {x}_{c r i t} \left|κ \geq u , S = i\right)\right)}$$

From this there results, together with the estimation of the overall collision rate from the extrapolation 209, denoted P(κ ≥ x_{crit}), the probability P(Sₓ) for the occurrence of a collision of severity class Sₓ with:

$$P \left({S}_{x}\right) = \text{P} \left(κ \geq {x}_{c r i t}\right) ⋅ {R}_{x} .$$

Because multiplication is then performed with a factor Rₓ ≤ 1, an altogether lower rate can be validated than was possible from the simple extrapolation in 209. This is achieved in that the ratio Rₓ is estimated purely by simulation-based testing and thus on the basis of an additional source of information in addition to the field test data.

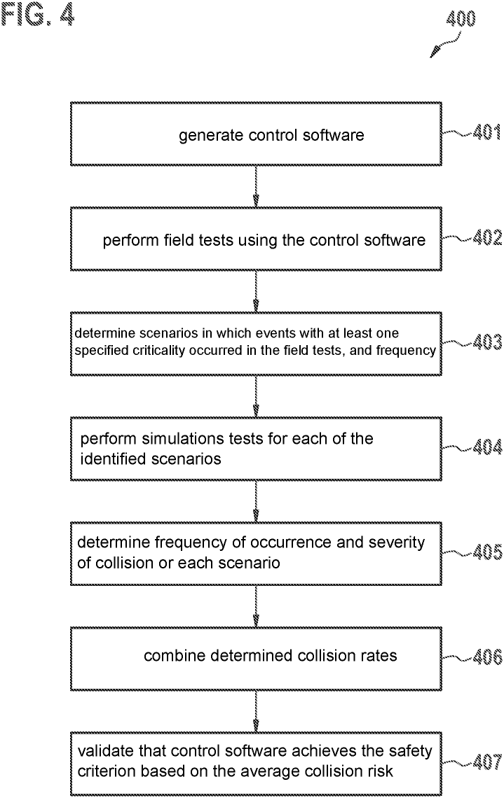

To summarize, according to various embodiments a method is provided as depicted in FIG. 4.

FIG. 4 shows a flowchart 400, which represents a method of controlling a robotic device according to one embodiment.

In 401, for example, a control software for the robotic device is generated or received, which is to be validated.

In 402, field tests are performed using the control software.

In 403, scenarios are determined in which events with at least one specified criticality occurred in the field tests, and, for each determined scenario, a frequency is determined with which the determined scenario including an event with at least the specified criticality occurs.

In 404, simulation test are performed for each determined scenario.

In 405, a collision rate is determined from the simulations for each determined scenario (and according to one embodiment at least one degree of collision severity is associated with each collision which has occurred in the simulation).

In 406, the determined collision rates (and optionally degrees of collision severity) are combined to yield an average collision risk over all determined scenarios, taking account of the determined frequency.

In 407, it is validated that the robotic device controlled using the control software achieves the safety criterion, if the average collision risk fulfills a specified safety criterion.

The validated control software may then be used to control a robotic device.

(Minimum) requirements on the scenario-specific collision rates (i.e. the determined collision rates) may also be set, i.e. safety criteria relating to the scenario-related collision rates may be examined.

The method of FIG. 4 may be carried out by one or more computers with one or more data processing units. The term “data processing unit” may be understood to mean any type of entity which enables the processing of data or signals. The data or signals may be processed for example according to at least one (i.e. one or more than one) specific function, which is carried out by the data processing unit. A data processing unit may comprise or be configured from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions, which are described herein in greater detail, may also be understood as a data processing unit or logic circuit arrangement. One or more of the method steps described here in detail may be carried out (e.g. implemented) by a data processing unit by one or more specific functions which are performed by the data processing unit.

The approach of FIG. 4 serves to validate a control software for producing a control signal for a robotic device. The term “robotic device” may be understood as referring to any technical system (with a mechanical part, the movement of which is controlled), such as for example a computer-controlled machine, an (automated or partly automated) vehicle, a domestic appliance, a power tool, a manufacturing machine, a personal assistant or an access control system.

Although specific embodiments have been depicted and described herein, it will be recognized by a person skilled in the relevant art that the specific embodiments which have been shown and described can be replaced by a wide variety of alternative and/or equivalent implementations without going beyond the scope of the present invention. This application is intended to cover any adaptations or variations of the specific embodiments discussed here.

What is claimed is:

1-7. (canceled)

8. A method for validating control software for a robotic device, comprising the following steps:
carrying out field tests using the control software;
determining scenarios in which events with at least one specified criticality have arisen in the field tests, and determining, for each determined scenario of the determined scenarios, a frequency with which the determined scenario including an event with at least the specified criticality occurs;
carrying out simulations for each of the determined scenarios;
determining, from the simulations, a collision rate for each of the determined scenarios;
combining the determined collision rates into an average collision risk over all the determined scenarios, taking into account the determined frequencies; and
validating the control software based on a comparison of the average collision risk with a safety criterion.

9. The method as recited in claim 8, wherein the criticality is specified in such a way that the scenarios include scenarios in which no collision has occurred.

10. The method as recited in claim 8, further comprising:
determining collision rates, and an average collision rate from the determined collision rates, for each degree of collision severity for at least one degree of collision severity and determining the collision risk from the average collision rate for each degree of collision severity.

11. The method as recited in claim 8, further comprising:
determining an average collision rate from the determined collision rates;
determining an extrapolated collision rate across the determined scenarios from results of the field tests by statistical extrapolation; and
comparing the average collision rate with the determined extrapolated collision rate.

12. The method as recited in claim 8, wherein for each of the determined scenarios, a Monte Carlo simulation is carried out in which parameters of the determined scenario are randomly varied.

13. A validating apparatus configured to:
receive field test data from field tests carried out using a control software for a robotic device;
determine scenarios in which events with at least one specified criticality occurred in the field tests, and determining, for each of the determined scenarios, a frequency with which the determined scenario including an event with at least the specified criticality occurs;
carry out simulations for each of the determined scenarios;
determine, from the simulations, a collision rate for each of the determined scenarios;
combine the determined collision rates into an average collision risk over all the determined scenarios taking account of the determined frequencies; and
validate the control software based on a comparison of the average collision risk with a safety criterion.

14. A non-transitory computer-readable medium on which are stored commands, the commands, when executed by a processor, cause the processor to perform the following steps:
receiving field test data from field tests carried out using a control software for a robotic device;
determining scenarios in which events with at least one specified criticality occurred in the field tests, and determining, for each of the determined scenarios, a frequency with which the determined scenario including an event with at least the specified criticality occurs;
carrying out simulations for each of the determined scenarios;
determining, from the simulations, a collision rate for each of the determined scenarios;
combining the determined collision rates into an average collision risk over all the determined scenarios taking account of the determined frequencies; and
validating the control software based on a comparison of the average collision risk with a safety criterion.
